(19) United States
(12) Patent Application Publication
(10) Pub. No.: US 2026/0246408 A1
(43) Pub. Date: Aug. 20, 2026

(54) WORK MACHINE

(71) Applicant: Koki Holdings Co., Ltd., Tokyo (JP)

(72) Inventors: Takeru KUMAKURA, Ibaraki (JP); Yuuichi TOYOSHIMA, Ibaraki (JP); Hideyuki TANIMOTO, Ibaraki (JP); Satoru GUNJI, Ibaraki (JP); Yuta KOIKE, Ibaraki (JP)

(73) Assignee: Koki Holdings Co., Ltd., Tokyo (JP)

(21) Appl. No.: 19/160,860

(22) PCT Filed: Mar. 28, 2024
(86) PCT No.: PCT/JP2024/012841

§ 371 Date: Aug. 29, 2025

(30) Foreign Application Priority Data
Mar. 31, 2023 (JP) 2023-057497

(51) Int. Cl. H02P 25/18; B25F 5/00; B27B 5/29; H02K 7/14; H02K 9/06; H02K 11/33; H02K 21/14

(52) U.S. Cl. CPC H02P 25/184; B25F 5/00; H02K 7/145; H02K 9/06; H02K 11/33; H02K 21/14; B27B 5/29; H02K 2211/03

(57) ABSTRACT

A parallel connection of U-phase stator coils (hereinafter, “U-phase parallel connection”), a parallel connection of V-phase stator coils (hereinafter, “V-phase parallel connection”), and a parallel connection of W-phase stator coils (hereinafter, “W-phase parallel connection”) are each achieved on the stator side without a conductive pattern of a stator substrate. On the other hand, forms of interconnection between the U-phase parallel connection, the V-phase parallel connection, and the W-phase parallel connection, that is, a stator coil wire-connection is not fixed on the stator side. Instead, the stator coil wire-connection is dynamically switched between a delta wire-connection and a star wire-connection, by relays provided on the stator substrate.

### TECHNICAL FIELD

The disclosure relates to a work machine.

### RELATED ART

Patent Document 1 discloses an electric tool as a work machine in which the wire-connection mode of the motor winding can be switched between series wire-connection and parallel wire-connection in response to the type of power supply (power supply voltage) connected. In addition, Patent Document 1 discloses attaching a substrate equipped with a relay for switching the wire-connection method to the end of a motor (end of a stator).

### CITATION LIST

### Patent Literature

Patent Document 1: Japanese Patent Application Laid-Open Publication No. 2017-121158

### SUMMARY OF INVENTION

### Technical Problem

If the connecting parts between windings and the connecting parts of relays for switching wire-connection are arranged in a concentrated manner, there is a risk that the concentrated part and its surrounding structure may become large, which in turn may ultimately lead to the increase in the size of the housing.

An object of the disclosure is to provide a work machine capable of suppressing the increase in the size of components or housing.

### Solution to Problem

One aspect of the disclosure is a work machine. This work machine includes a motor having a plurality of coils; an inverter circuit configured to supply current to the plurality of coils; and a wire-connection circuit connected to the inverter circuit and configured to wire-connect the plurality of coils. The wire-connection circuit includes a first wire-connection connecting part that becomes conductive only in the case where a wire-connection of the plurality of coils is a first wire-connection; a second wire-connection connecting part that becomes conductive only in the case where the wire-connection of the plurality of coils is a second wire-connection; and a common wire-connection connecting part configured to connect between the plurality of coils and becomes conductive in both the first wire-connection and the second wire-connection. Among the common wire-connection connecting part, the first wire-connection connecting part, and the second wire-connection connecting part, one is provided on a substrate, and at least one of the other two is provided separately from the substrate.

The disclosure may be expressed as “electric work machine”, “electric tool”, “electrical device”, etc., and those expressed in such ways are also valid as aspects of the disclosure.

### Effects of Invention

According to the disclosure, it is possible to provide a work machine capable of suppressing the increase in the size of components or housing.

### BRIEF DESCRIPTION OF DRAWINGS

FIG. 1 is a left side view with a partial cross-section of a work machine 1 according to embodiment 1 of the disclosure.

FIG. 2 (A) is a cross-sectional view along A-A in FIG. 1. (B) is an enlarged view of part B in (A) of FIG. 2.

FIG. 3 is a perspective view of a motor 30 and its surrounding configuration in the work machine 1.

FIG. 4 is a top view of the motor 30 and its surrounding configuration.

FIG. 5 is a top cross-sectional view of the motor 30 and its surrounding configuration.

FIG. 6 is a view of a stator substrate 27 of the work machine 1 as seen from the left side.

FIG. 7 is a circuit block diagram of the work machine 1.

FIG. 8 (A) is a circuit diagram of a motor wire-connection circuit 46 in FIG. 7. (B) is a circuit diagram showing the motor wire-connection circuit 46 in FIG. 7 divided into a stator 45 side and the stator substrate 27 side.

FIG. 9 is an illustrative diagram of the winding process of the stator 45.

FIG. 10 is a graph showing the time variation of the actual measured values of the temperature of the switching elements (FETs) of a inverter circuit 47, the temperature of relays RY1 to RY3 (relays for delta wire-connection), and the air temperature when the work machine 1 is continuously operated under no-load state with the stator coils 37 wire-connected in a delta wire-connection.

FIG. 11 is a graph showing the time variation of the actual measured values of the temperature of the switching elements (FETs) of the inverter circuit 47, the temperature of the relays RY1 to RY3 (relays for delta wire-connection), and the air temperature when high-load operations are intermittently and repeatedly performed on the work machine 1 with the stator coils 37 wire-connected in a delta wire-connection.

FIG. 12 (A) is a diagram showing the magnetic force lines generated by a relay coil 56 of a relay 28 and the relative arrangement of the relay 28 and a hall IC 29 for rotation detection in the case where an iron core 55 of the relay 28 is perpendicular to the surface of the stator substrate 27. (B) is a diagram showing the magnetic force lines generated by the relay coil 56 of the relay 28 and the relative arrangement of the relay 28 and the hall IC 29 for rotation detection in the case where the iron core 55 of the relay 28 is parallel to the surface of the stator substrate 27.

FIG. 13 (A) is a circuit diagram of the motor wire-connection circuit in a work machine according to Embodiment 2 of the disclosure. (B) is a circuit diagram showing the motor wire-connection circuit of (A) of FIG. 13 divided into the stator side and the stator substrate side.

FIG. 14 (A) is a circuit diagram of the motor wire-connection circuit in a work machine according to Embodiment 3 of the disclosure. (B) is a circuit diagram of the motor wire-connection circuit in a work machine according to Embodiment 4 of the disclosure.

FIG. 15 is a diagram showing a modification example of the motor wire-connection circuit 46 in the disclosure, illustrating a configuration where a circuit connecting the same phases is provided on the stator substrate.

FIG. 16 is a diagram showing a modification example of the motor wire-connection circuit 46 in the disclosure, illustrating a configuration where relays are provided on an inverter substrate 23 on which the inverter circuit is mounted.

### DESCRIPTION OF THE EMBODIMENTS

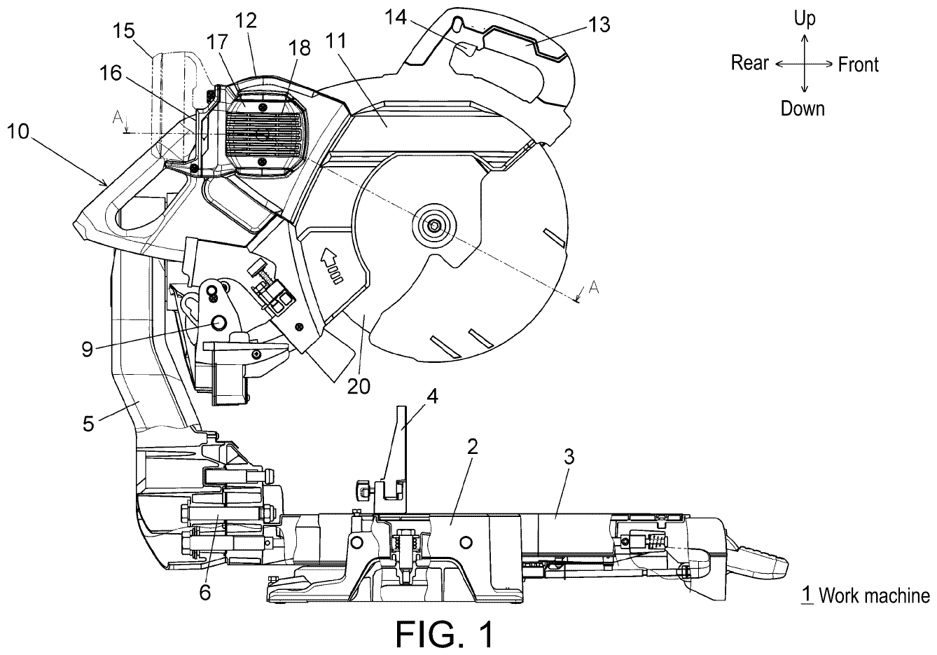

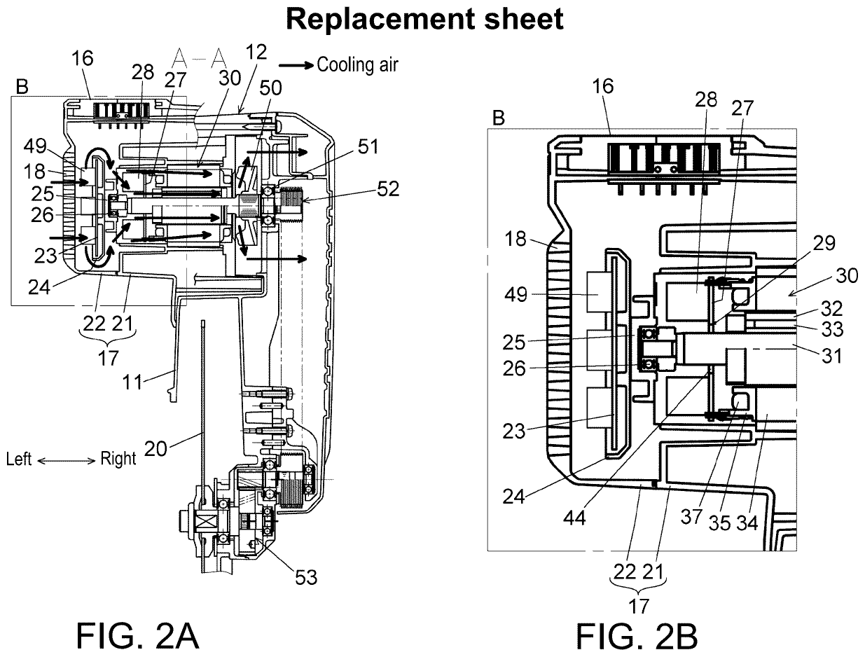

(Embodiment 1) FIG. 1 to FIG. 12 relate to a work machine 1 according to Embodiment 1 of the disclosure. The front-rear, up-down, and left-right directions, which are mutually perpendicular in the work machine 1, are defined by FIG. 1 and (A) of FIG. 2. The work machine 1 is a table-top cutting machine (table-top circular saw).

The work machine 1 includes a base 2, a turntable 3, and a fence 4. The base 2 and the turntable 3 constitute a base part. The base 2 is placed on a workbench or the like. The turntable 3 is embedded in a central part of the base 2 and is pivotable with respect to the base 2 by a pivoting axis parallel to the up-down direction. An upper surface of the turntable 3 serves as a placement surface (base surface) for placing workpieces such as wood. An upper surface of the base 2 and the upper surface of the turntable 3 are substantially flush with each other. The fence 4 is provided on the upper surface of the base 2. By abutting the workpiece against the fence 4, stable cutting operation becomes possible.

The work machine 1 includes a holder 5. The holder 5 is connected to a rear end of the turntable 3 via a tilting shaft 6 and rises upward from the rear end of the turntable 3. The tilting shaft 6 is a shaft that is substantially parallel to the upper surface of the turntable 3 and parallel to a side surface of a cutting blade 20. An axis of the tilting shaft 6 and the upper surface of the turntable 3 are at substantially the same position in the up-down direction. The holder 5 is tiltable with respect to the turntable 3 around the tilting shaft 6 to at least one of the left and right sides at a predetermined angle, for example, within a range of 45 degrees. The tilting position of the holder 5 may be fixed or released by a clamp lever (not shown).

The work machine 1 includes a cutting part 10. The cutting part 10 is connected to an upper part of the holder 5 via an oscillating shaft 9 and extends in the front-upper direction. The oscillating shaft 9 is a shaft that is substantially parallel to the rotation axis of the cutting blade 20. The cutting part 10 is capable of oscillating up and down around the oscillating shaft 9. A spring (not shown) is provided around the oscillating shaft 9 to urge the cutting part 10 upward with respect to the holder 5. FIG. 1 shows a state where the cutting part 10 is at the upper limit oscillation position. The cutting part 10 is connected to the holder 5 via a slide rail (not shown) and is slidable in the front-rear direction with respect to the holder 5 by being supported by the slide rail.

The cutting part 10 includes a gear case (saw cover) 11 and a housing 12. The gear case 11 is made of metal such as aluminum, for example. The gear case 11 covers the upper outer periphery of the cutting blade 20. The housing 12 is, for example, a resin molded body, connected to the gear case 11, and positioned to the left of the gear case 11. The housing 12 includes a handle housing 13 and a motor accommodating part 17.

A trigger switch 14 (drive operation part) is provided in the grip part of the handle housing 13, allowing the operator to switch a motor 30 on and off. At the rear part of the motor accommodating part 17A is a battery pack mounting part 16, where a battery pack 15 may be detachably mounted. The work machine 1 operates on the power of the battery pack 15. As shown in (A) of FIG. 2, the motor accommodating part 17 is a combination of a motor housing 21 and a cover 22 fastened together by screws or the like.

The motor housing 21 is a non-divided tubular body with its central axis parallel to the left-right direction. The cover 22 covers the left side opening of the motor housing 21. The motor housing 21 accommodates the motor 30 and a stator substrate 27. An air inlet 18 (air window) is provided on the left side of the cover 22 to take in cooling air generated by the fan 50, which will be described later.

The cutting part 10 includes a motor 30. The motor 30 is, in this case, a 4-pole 6-slot 3-phase brushless motor. In other words, the motor 30 has six stator coils. The motor 30 includes a motor shaft 31, a rotor core 32, a rotor magnet 33, a stator core 34, a left insulator 35, a right insulator 36, and a stator coil 37.

The motor shaft 31 extends perpendicular to the side surface of the cutting blade 20. The left part of the motor shaft 31 is supported by a left bearing 26. The left bearing 26 is retained by a bearing retainer part 25 of the motor housing 21. The right part of the motor shaft 31 is supported by a right bearing 51.

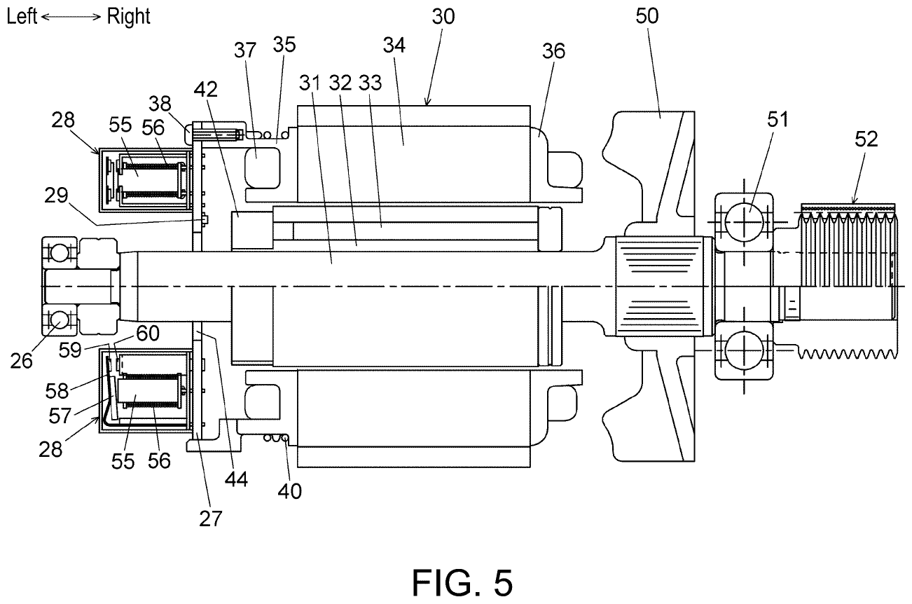

The rotor core 32 is approximately cylindrical in shape and is provided around the motor shaft 31, rotating integrally with the motor shaft 31. The rotor magnet 33 is inserted and retained in the rotor core 32. Four rotor magnets 33 are provided at intervals of, for example, 90 degrees in the circumferential direction of the rotor core 32. As shown in FIG. 5, a sensor magnet 42 is provided on the left end surface of the rotor core 32. There are four sensor magnets 42, each provided at the same circumferential position as each rotor magnet 33. The magnetic pole surfaces of the sensor magnet 42 are the surface on the rotor core 32 side and the side surface. The magnetic field generated by the sensor magnet 42 is detected by the hall IC 29, which will be described later. The rotor core 32, the rotor magnet 33, and the sensor magnet 42 constitute the rotor of the motor 30.

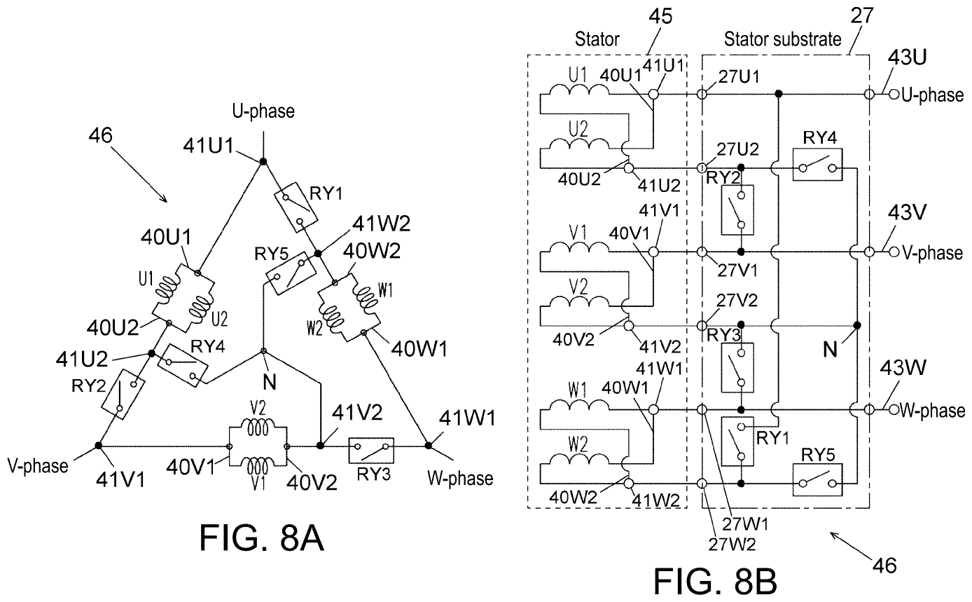

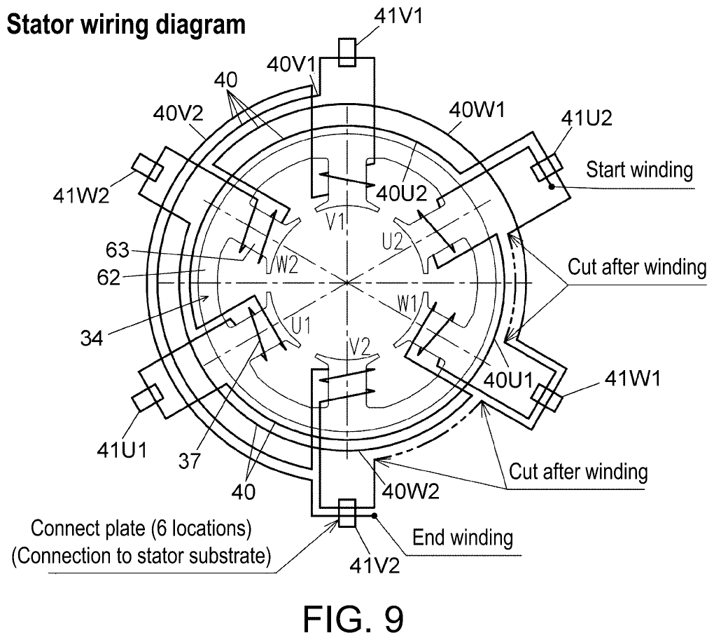

A stator core 34 is retained in the motor housing 21. As shown in FIG. 9, the stator core 34 includes a yoke part 62 and teeth parts 63. The yoke part 62 is a tubular part (cylindrical part) that coaxially surrounds the rotor core 32. The teeth parts 63 protrude radially inward from the yoke part 62. Six teeth parts 63 are provided at intervals of, for example, 60 degrees in the circumferential direction of the stator core 34. The stator coil 37 is wound around each teeth part 63. There are two stator coils 37 for each of the U-phase, V-phase, and W-phase, and in (A) and (B) of FIG. 8 and FIG. 9, each stator coil 37 is distinguished as U-phase stator coils U1, U2, V-phase stator coils V1, V2, and W-phase stator coils W1, W2. The U-phase corresponds to the first phase of the disclosure, and the stator coils U1, U2 constituting the U-phase correspond to the first coil and the second coil of the disclosure, respectively. The V-phase corresponds to the second phase of the disclosure, and the stator coils V1, V2 constituting the V-phase correspond to the third coil and the fourth coil of the disclosure, respectively. The W-phase corresponds to the third phase of the disclosure, and the stator coils W1, W2 constituting the W-phase correspond to the fifth coil and the sixth coil of the disclosure, respectively.

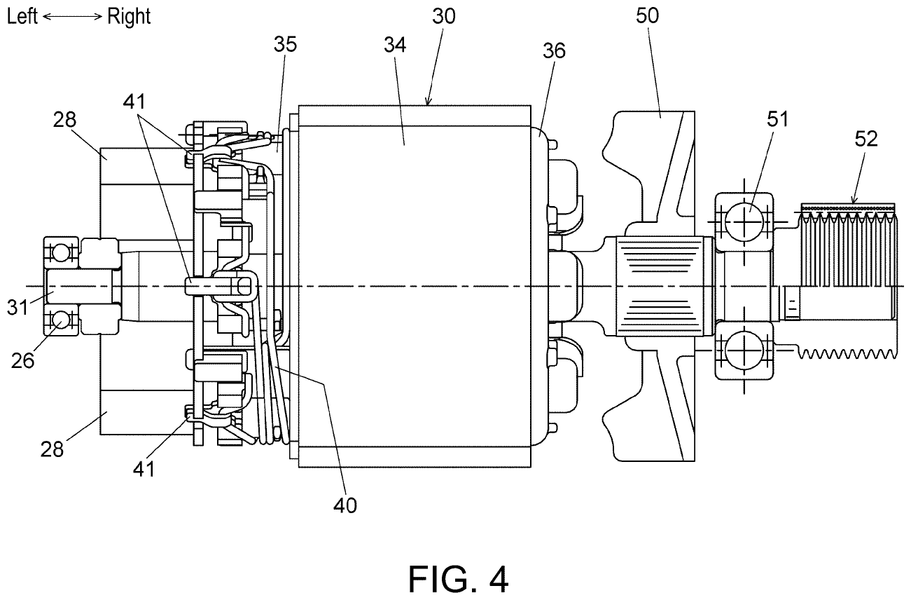

The left insulator 35 is, for example, a resin molded body provided on the left side of the stator core 34 and intervenes between the stator coil 37 and the stator core 34. As shown in FIG. 4, the left insulator 35 serves as a guide for a crossover line 40 that crossovers the stator coils 37 of the same phase in the circumferential direction of the motor shaft 31 on the left side of the stator core 34. The left insulator 35 retains a connect plate 41, which will be described later. The right insulator 36 is, for example, a resin molded body provided on the right side of the stator core 34 and intervenes between the stator coil 37 and the stator core 34. The stator core 34, the left insulator 35, the right insulator 36, the stator coil 37, and the connect plate 41 constitute the stator of the motor 30.

The rotation of the motor 30, that is, the rotation of the motor shaft 31, is transmitted forward by a winding transmission mechanism 52, and further decelerated by a deceleration mechanism 53 and transmitted to the cutting blade 20.

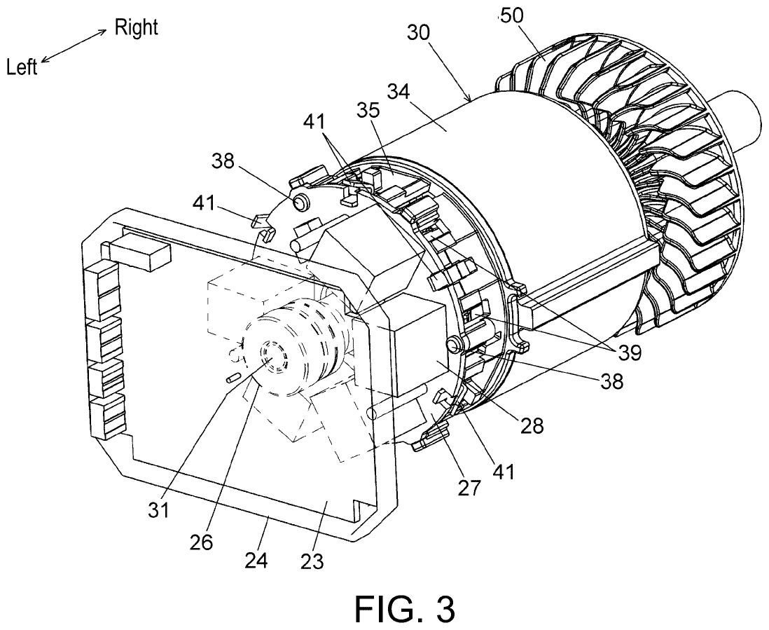

The cutting part 10 includes a stator substrate 27 as a second substrate. As shown in FIG. 3, the stator substrate 27 is fixed to the left insulator 35 by, for example, three screws 38 and is supported in a posture perpendicular to the motor shaft 31. The stator substrate 27 is approximately circular in shape with a smaller diameter than the stator of the motor 30.

Five relays 28 are provided on the left side of the stator substrate 27. In (A) and (B) of FIG. 8, the five relays are distinguished as relays RY1 to RY5. As shown in FIG. 5, a relay 28 is configured such that an iron plate 57 provided on a leaf spring 58 is attracted to a relay coil 56 by a magnetic field generated by flowing current through the relay coil 56 wound around an iron core 55 as a magnetic core, and a movable contact 59 that operates integrally with the iron plate 57 contacts a fixed contact 60 to turn on (conduct the current path). When the current to the relay coil 56 is stopped, the movable contact 59 separates from the fixed contact 60 by the elastic force of the leaf spring 58, and the relay 28 turns off. The relay 28 is a through-hole mounting type in this case. That is, the terminals of the relay 28 pass through the through-holes of the stator substrate 27 and are electrically connected to the stator substrate 27 by soldering or the like. The relay 28 is configured to have two terminals for flowing current through the relay coil 56, two terminals for connecting to the current path to be switched between conduction and disconnection, and a total of four terminals are connected to the stator substrate 27. The illustration of the terminals is omitted.

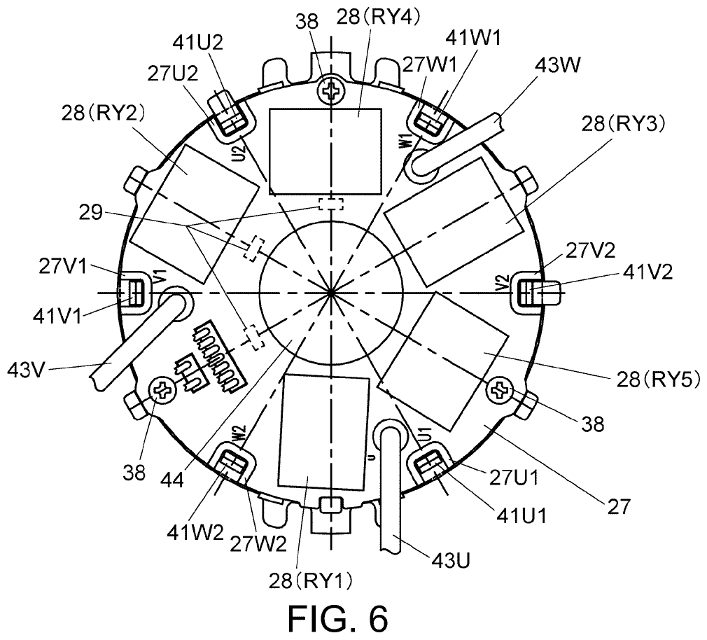

As shown in FIG. 5 and FIG. 6, a Hall IC 29 as a magnetic sensor is provided on the right side of the stator substrate 27, that is, on the opposite side of the surface where the relay 28 is mounted on the stator substrate 27. The Hall IC 29 is positioned inward of the relay 28 in the radial direction of the motor shaft 31. Moreover, FIG. 6 shows the left side of the stator substrate 27, but the Hall IC 29 provided on the right side of the stator substrate 27 is indicated by a dashed line. Three Hall ICs 29 are provided at 60-degree intervals in the circumferential direction of the motor shaft 31. In this embodiment, the Hall IC 29 is configured to detect a magnetic field in the direction perpendicular to the stator substrate 27 (left-right direction). More specifically, in this embodiment, the Hall IC 29 is configured to output a voltage with a magnitude corresponding to the magnitude of the magnetic flux density according to the magnetic flux density in the direction perpendicular to the stator substrate 27.

The electrical connection between the stator substrate 27 and the stator coil 37 is made by a metal connect plate 41 shown in FIG. 3, FIG. 4, and FIG. 6. The connect plate 41 is, for example, a fusing terminal. The connect plate 41 is retained in the left insulator 35, for example, by integral molding. The connect plate 41 may also be configured as a separate body from the insulator and assembled together. Six connect plates 41 are provided, for example, at 60-degree intervals in the circumferential direction of the motor shaft 31. Moreover, in FIG. 3, each connect plate 41 is shown in an open state before winding or hooking and clamping the stator coil 37. As shown in FIG. 4, the crossover line 40 that connects the stator coils 37 of the same phase or the ends of the stator coils 37 are wound around or hooked onto each connect plate 41. Each connect plate 41 is electrically connected to the stator substrate 27 in a closed state as shown in FIG. 4. In FIG. 6 and FIG. 9, the six connect plates 41 are distinguished as the connect plates 41U1, 41U2, 41V1, 41V2, 41W1, and 41W2, matching the phases of the corresponding stator coils 37. Moreover, as shown in FIG. 6, conduction parts 27U1, 27U2, 27V1, 27V2, 27W1, and 27W2 are formed on the stator substrate 27, each electrically connected to the six connect plates 41. The conduction parts 27U1-W2 are lands that are electrically connected to an unillustrated conductive pattern formed on the stator substrate 27. These conduction parts 27U1-W2 are electrically connected and fixed to the respective connect plates 41U1-W2 by connection means such as solder. The conduction parts 27U1-W2 are the electrical connecting parts between the coil and the circuit board in the disclosure, of which conduction part 27U1 corresponds to a first connecting part, conduction part 27U2 to a second connecting part, conduction part 27V1 to a third connecting part, conduction part 27V2 to a fourth connecting part, conduction part 27W1 to a fifth connecting part, and conduction part 27W2 to a sixth connecting part. The connect plates 41U1-W2 are the electrical connection receiving parts between the coil and the circuit board in the disclosure, of which the connect plate 41U1 corresponds to the first connection receiving part, the connect plate 41U2 to the second connection receiving part, the connect plate 41V1 to the third connection receiving part, the connect plate 41V2 to the fourth connection receiving part, the connect plate 41W1 to the fifth connection receiving part, and the connect plate 41W2 to the sixth connection receiving part. The connect plate (connection receiving part) has the function of consolidating the connection locations (consolidated to two locations in this embodiment) when connecting both ends of two coils constituting one phase (a total of four locations) to the circuit board.

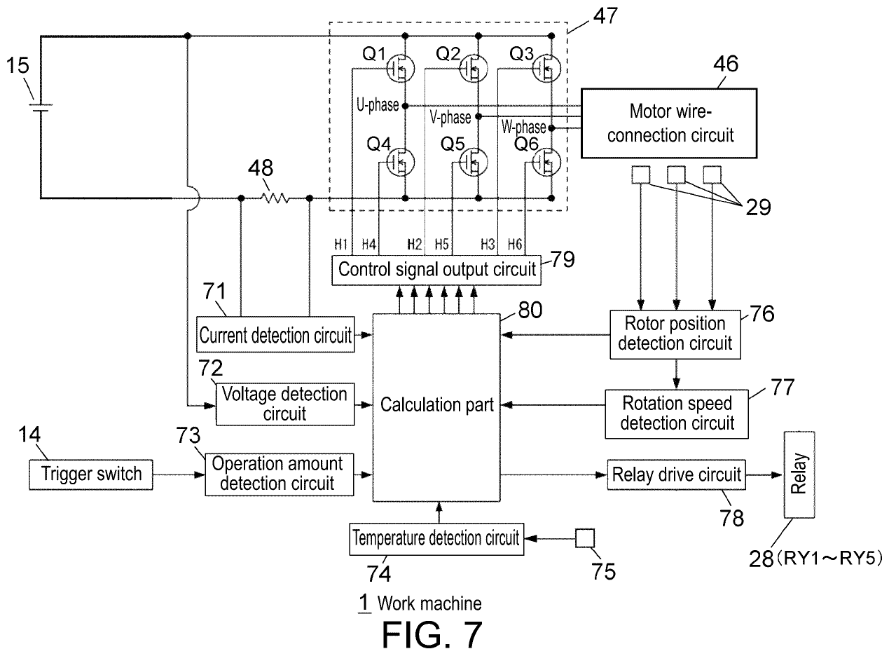

The cutting part 10 includes an inverter substrate 23 as a first substrate and a substrate case 24 that accommodates and retains it. The substrate case 24 is positioned to the left of the bearing retainer part 25. The inverter substrate 23 is retained within the substrate case 24 in a vertical posture with respect to the motor shaft 31 to the left of the bearing retainer part 25. The inverter substrate 23 and the substrate case 24 are positioned to the left of the motor housing 21 and have dimensions larger than the left side opening of the motor housing 21 when viewed from the axial direction of the motor shaft 31. As shown in (A) and (B) of FIG. 2, a switching element 49 for energizing the stator coil 37 is provided on the left side of the inverter substrate 23. The switching element 49 corresponds to switching elements Q1-Q6 such as FETs that constitute an inverter circuit 47 shown in FIG. 7. Moreover, the illustration of the switching element 49 is omitted in FIG. 3. Additionally, circuit components such as microcontrollers that constitute a calculation part 80 shown in FIG. 7 are also mounted on the inverter substrate 23, but the illustration of these circuit components is omitted in FIG. 3. The switching elements Q1-Q6 are examples of a first switch part.

The inverter substrate 23 and the stator substrate 27 are electrically connected by a U-phase power line 43U, a V-phase power line 43V, and a W-phase power line 43W shown in FIG. 6. The U-phase power line 43U extends from the interconnecting part of the switching elements Q1 and Q4 shown in FIG. 7 on the inverter substrate 23 and is electrically connected to the stator substrate 27. The V-phase power line 43 V extends from the interconnecting part of the switching elements Q2 and Q5 shown in FIG. 7 on the inverter substrate 23 and is electrically connected to the stator substrate 27. The W-phase power line 43W extends from the interconnecting part of the switching elements Q3 and Q6 shown in FIG. 7 on the inverter substrate 23 and is electrically connected to the stator substrate 27. In other words, as shown in FIG. 7, the U-phase power line 43U, the V-phase power line 43V, and the W-phase power line 43W are three power supply wirings that extend from the U-phase, V-phase, and W-phase of the inverter circuit 47 to a motor wire-connection circuit 46, respectively.

The cutting part 10 includes a fan 50. The fan 50 is a centrifugal fan and is provided on the motor shaft 31 to the right of the stator core 34, rotating integrally with the motor shaft 31. The flow of cooling air generated by the fan 50 is shown by the arrow in (A) of FIG. 2. The cooling air enters the cover 22 through the air inlet 18 of the cover 22, cools the inverter substrate 23 and the switching element 49, then circulates to the right of the inverter substrate 23 to cool the stator substrate 27 and the relay 28, and further cools the motor 30 before being drawn into the fan 50. In other words, the relay 28 is positioned downstream of the cooling air flow relative to the switching element 49. The gap between the inner edge of a via hole 44 in a central part of the stator substrate 27 shown in (B) of FIG. 2 and the outer circumferential surface of the motor shaft 31, and the gap between a notch 39 at the left end of the left insulator 35 shown in FIG. 3 and the stator substrate 27 serve as the air passage for the cooling air to flow towards the motor 30 side after cooling the stator substrate 27 and the relay 28. The cooling air drawn into the fan 50 flows in the centrifugal direction, is guided by the inner wall of the housing 12 to flow to the right, and is exhausted from the housing 12 through an unillustrated exhaust port. The notch 39 is configured to be at least partially in the same position as the relay 28 in the rotation direction of the motor shaft 31. In other words, each notch 39 is placed in a position corresponding to each relay 28. This arrangement allows the air passing through the notch 39 to more easily hit the relay 28, enabling suitable cooling of the relay 28. In this embodiment, the six notches 39 are provided in a total of six locations.

FIG. 7 is a circuit block diagram of the work machine 1. (A) and (B) of FIG. 8 show the specific configuration of the motor wire-connection circuit 46 in FIG. 7. The motor wire-connection circuit 46 includes U-phase stator coils U1, U2, V-phase stator coils V1, V2, W-phase stator coils W1, W2, and the relays RY1 to RY5. The relays RY1 to RY5 are wire-connection switching parts that switch the wire-connection of the U-phase stator coils U1, U2, V-phase stator coils V1, V2, and W-phase stator coils W1, W2 (hereinafter referred to as “stator coil wire-connection”) between a delta wire-connection and a star wire-connection (Y wire-connection), and are examples of a second switch part. The nominal heat resistance temperature of the relays RY1 to RY5 (hereinafter referred to as “relay heat resistance temperature”) is higher than the nominal heat resistance temperature of the switching elements Q1 to Q6 (49) of the inverter circuit 47 (hereinafter referred to as “FET heat resistance temperature”). The delta wire-connection and the star wire-connection have different motor driving characteristics, and how to apply each of them in the control system is adjusted as appropriate according to the work form and the type of work machine. For example, it may be configured to drive with the delta wire-connection under low-load and with the star wire-connection under high-load.

In the case where the stator coil wire-connection is set as the delta wire-connection, which is the first wire-connection, the relays RY1 to RY3 are ON (conductive state), and relays RY4 and RY5 are OFF (disconnected state). In the case where the stator coil wire-connection is set as the star wire-connection, which is the second wire-connection, the relays RY1 to RY3 are OFF (disconnected state), and relays RY4 and RY5 are ON (conductive state). The crossover line 40 functions as a circuit connecting coils of the same phase. As shown in FIG. 8 and FIG. 9, the crossover line 40 includes a first U-phase crossover line 40U1 and a second U-phase crossover line 40U2 connecting U-phase coils to each other, a first V-phase crossover line 40V1 and a second V-phase crossover line 40V2 connecting V-phase coils to each other, and a first W-phase crossover line 40W 1 and a second W-phase crossover line 40W 2 connecting W-phase coils to each other. The crossover line 40 connecting stator coils of the same phase and each connect plate 41 are configured as current paths (in conductive state) in both the delta wire-connection and the star wire-connection. In other words, the crossover line 40 and each connect plate 41 are examples of the common wire-connection connecting part. The relays RY1 to RY3 are relays for the delta wire-connection and are examples of the first wire-connection connecting part (first switching element) in the disclosure. Relays RY4 and RY5 are relays for the star wire-connection and are examples of the second wire-connection connecting part (second switching element) in the disclosure.

The inverter circuit 47 converts the direct current output from the battery pack 15 into alternating current and supplies it to the motor wire-connection circuit 46. The inverter circuit 47 includes the switching elements Q1 to Q6 such as FETs or IGBTs (Insulate-Gate Bipolar Transistor) connected in a three-phase bridge configuration. As mentioned above, the switching elements Q1 to Q6 are examples of the first switch part. A resistor 48 is provided in the path of the current flowing through the motor wire-connection circuit 46 (hereinafter referred to as “motor current”). A current detection circuit 71 detects the motor current based on the voltage drop across the resistor 48 and transmits it to the calculation part 80. A voltage detection circuit 72 detects the output voltage of the battery pack 15 (hereinafter referred to as “battery voltage”) and transmits it to the calculation part 80. An operation amount detection circuit 73 detects the ON-OFF state and operation amount of the trigger switch 14 and transmits it to the calculation part 80.

A thermistor 75, serving as a temperature detection element, is provided on the inverter substrate 23 and positioned in the vicinity of one of the switching elements Q1 to Q6, outputting a signal corresponding to the temperature of the respective switching element (hereinafter referred to as “FET temperature”). A temperature detection circuit 74 detects the temperature of the respective switching element based on the signal from the thermistor 75 and transmits it to the calculation part 80. Moreover, the switching elements Q1 to Q6 are identical elements with common ON resistance and heat resistance temperature, and their temperature changes are substantially the same. Therefore, it is sufficient to monitor the temperature change of one of the switching elements Q1 to Q6.

A rotor position detection circuit 76 detects the rotor rotation position of the motor 30 based on the output signal (voltage) from the Hall IC 29 and transmits it to the calculation part 80. A rotation speed detection circuit 77 detects the rotation speed of the motor 30 (hereinafter referred to as “motor rotation speed”) based on the output signal from the rotor position detection circuit 76 and transmits it to the calculation part 80. A relay drive circuit 78 controls the ON-OFF state of the relay 28 (relays RY1 to RY5) according to the control of the calculation part 80. A control signal output circuit 79 controls the ON-OFF state of the switching elements Q1 to Q6 of the inverter circuit 47 according to the control of the calculation part 80.

The calculation part 80 is a control part that controls the overall operation of the work machine 1. The calculation part 80 monitors the motor current, battery voltage, ON-OFF state and operation amount of the trigger switch 14, FET temperature, rotor rotation position, and motor rotation speed, while controlling the drive of the inverter circuit 47 (PWM control) through the control signal output circuit 79 in response to the operation of the trigger switch 14, thereby controlling the drive of the motor 30.

The calculation part 80 possesses an overload protection function (overcurrent protection function) that stops power supply to the motor 30 by turning off all switching elements Q1 to Q6 even when the trigger switch 14 is in the ON state if the motor current satisfies the overload protection operation condition (overcurrent protection operation condition). The overload protection operation condition is, for example, when the motor current becomes equal to or greater than the overload protection threshold (overcurrent protection threshold).

The calculation part 80 possesses a high temperature protection operation function that stops power supply to the motor 30 by turning off all switching elements Q1 to Q6 even when the trigger switch 14 is in the ON state if the FET temperature satisfies the high temperature protection operation condition. The high temperature protection operation condition is, for example, when the FET temperature becomes equal to or greater than a predetermined temperature (high temperature protection threshold).

In the overload protection function and high temperature protection operation function, turning off all switching elements Q1 to Q6 to stop power supply to the motor 30 is an example of controlling such that current does not flow through the relays RY1 to RY5 (power supply to the relays RY1 to RY5 is disconnected). The calculation part 80 may turn off all relays RY1 to RY5 instead of or in addition to turning off all switching elements Q1 to Q6. In other words, the switching elements Q1 to Q6 as the first switch part and the relays RY1 to RY5 as the second switch part may each function as a means to disconnect power supply to the motor 30.

During the operation of the motor 30, both the FET temperature and the temperature of the relays RY1 to RY5 (hereinafter referred to as “relay temperature”) increase. Therefore, it is conceivable to perform both control to monitor the FET temperature to prevent the FET temperature from exceeding the FET heat resistance temperature and control to monitor the relay temperature to prevent the relay temperature from exceeding the relay heat resistance temperature. However, if the thermistor 75 for monitoring the FET temperature and the thermistor for monitoring the relay temperature are provided separately, there is a risk that costs will increase, the stator substrate 27 for mounting the thermistor will become larger, and the work machine 1 will become larger.

Therefore, the work machine 1 is configured such that the FET temperature satisfies the high temperature protection operation condition before the relay temperature reaches the relay heat resistance temperature. In other words, it is configured such that when the FET temperature exceeds a predetermined temperature (high temperature protection threshold), the relay temperature becomes lower than the relay heat resistance temperature. Under this configuration, the work machine 1 does not include a dedicated thermistor for monitoring the relay temperature, and the calculation part 80 indirectly controls the relay temperature not to exceed the relay heat resistance temperature by controlling the FET temperature not to exceed the FET heat resistance temperature.

As shown in (A) and (B) of FIG. 8, U-phase stator coils U1 and U2 are connected in parallel with each other, V-phase stator coils V1 and V2 are connected in parallel with each other, and W-phase stator coils W1 and W2 are connected in parallel with each other. These parallel connections are made by the first U-phase crossover line 40U1, the second U-phase crossover line 40U2, the first V-phase crossover line 40V1, the second V-phase crossover line 40V2, the first W-phase crossover line 40W1, and the second W-phase crossover line 40W2. (B) of FIG. 8 shows that the parallel connection (parallel wire-connection) of the stator coils of each phase is completed on a stator 45 side, that is, it is established without depending on the conductive pattern (wiring pattern) of the stator substrate 27. Thus, only 6 connect plates 41 are required, and also the complication of the conductive pattern of the stator substrate 27 or the increase in the size of the stator substrate 27 can be suppressed.

The winding process of the stator 45 is described using FIG. 9. In this example, the winding starting part of the wire material that becomes the stator coil is entangled with the connect plate 41U2, wound with the stator coil U2, led around 180 degrees in the clockwise direction in FIG. 9, hooked on the connect plate 41U1, wound with the stator coil U1, led around 180 degrees in the clockwise direction in FIG. 9, and hooked on the connect plate 41U2. This results in the U-phase stator coils U1 and U2 being in a parallel connection state with each other.

Subsequently, the wire material hooked on the connect plate 41U2 is led around 60 degrees in the clockwise direction in FIG. 9, hooked on the connect plate 41W1, wounded with the stator coil W1, led around 180 degrees in the clockwise direction in FIG. 9, hooked on the connect plate 41W2, wounded with the stator coil W2, led around 180 degrees in the clockwise direction in FIG. 9, and hooked on the connect plate 41W1. This results in the W-phase stator coils W1 and W2 being in a parallel connection state with each other.

Subsequently, the wire material hooked on the connect plate 41W1 is led around 60 degrees in the clockwise direction in FIG. 9, hooked on the connect plate 41V2, wounded with the stator coil V2, led around 180 degrees in the clockwise direction in FIG. 9, hooked on the connect plate 41V1, wounded with the stator coil V1, led around 180 degrees in the counterclockwise direction in FIG. 9, and the winding ending part is entangled with the connect plate 41V2. This results in the V-phase stator coils V1 and V2 being in a parallel connection state with each other.

The above winding step may be performed by an automatic winding machine that is not shown. Subsequently, the unnecessary parts of the wire material (the parts shown by the dash-dot lines in FIG. 9), namely the part crossing between the connect plates 41U2 and W1, and the part crossing between the connect plates 41W1 and 41V2, are cut and removed. This completes the connection shown within the dashed line of the stator 45 in (B) of FIG. 8. The crossover lines 40 connecting the stator coils of the same phase and each connect plate 41 are examples of the common wire-connection connecting part. In the above winding step, there is no particular limitation on which stator coil to start winding from.

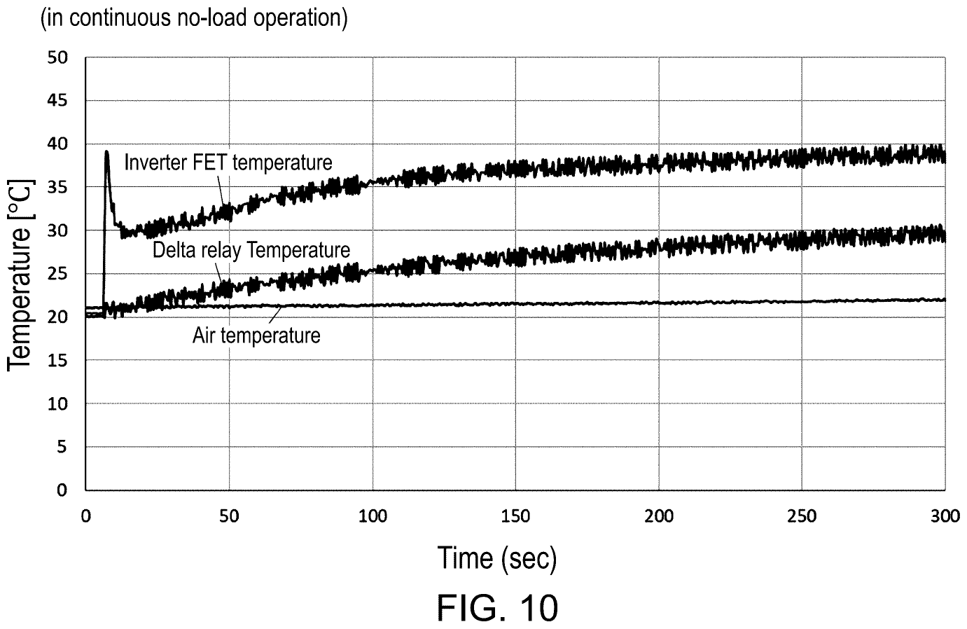

FIG. 10 is a graph showing the time variation of the actual measured values of FET temperature, the temperature of the relays RY1 to RY3 (relays for delta wire-connection) (hereinafter referred to as “delta relay temperature”), and air temperature when the work machine 1 is continuously operated in a no-load state with the stator coil wire-connection as delta wire-connection. In FIG. 10, the initial temporary rapid rise in FET temperature is due to the starting current of the motor 30. Both FET temperature 69 and the delta relay temperature increased with the passage of time, but each peaked around 250 seconds. This is because an equilibrium state is reached between the heat generation due to current flow and the cooling by the cooling air generated by the fan 50. It is configured that the FET temperature is higher than the delta relay temperature both when the temperature is rising and in the equilibrium state. Although not shown, the relationship between the FET temperature and the temperature of relays RY4 and RY5 (hereinafter referred to as “star relay temperature”) in the case where the stator coil wire-connection is in the star wire-connection also shows a similar trend to FIG. 10.

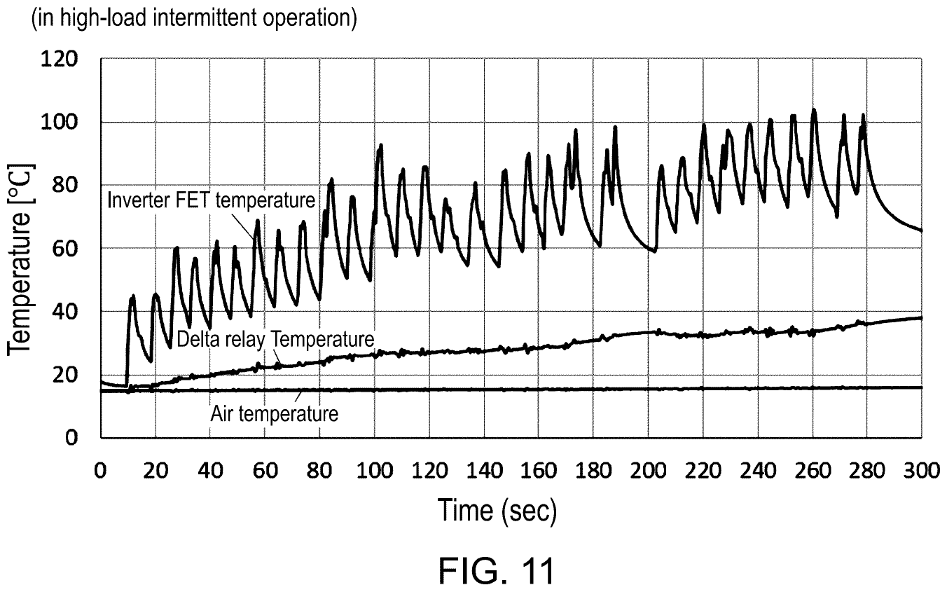

FIG. 11 is a graph showing the time variation of the actual measured values of FET temperature, delta relay temperature, and air temperature when high-load operations are intermittently and repeatedly performed in the work machine 1 with the stator coil wire-connection as delta wire-connection. In FIG. 11, the FET temperature repeated a temperature change of rising during high-load operations and falling during operation stops, while its time average value increased. The delta relay temperature increased while repeating small ups and downs at a lower temperature than the FET temperature. Although not shown, the relationship between the FET temperature and the star relay temperature in the case where the stator coil wire-connection is in the star wire-connection also shows a similar trend to FIG. 11.

As shown in FIG. 10 and FIG. 11, in either case (especially when operations are performed for more than a predetermined time), it is configured such that the delta relay temperature is lower than the FET temperature. The same applies between the star relay temperature and the FET temperature. In this embodiment, the relay heat resistance temperature is set higher than the FET heat resistance temperature, thereby configuring the disclosure such that FET temperature satisfies the high temperature protection operation condition before the relay temperature reaches the relay heat resistance temperature. As a result, when the FET temperature exceeds a predetermined temperature (high temperature protection threshold), the relay temperature is lower than the relay heat resistance temperature, thus temperature protection for the relay is activated.

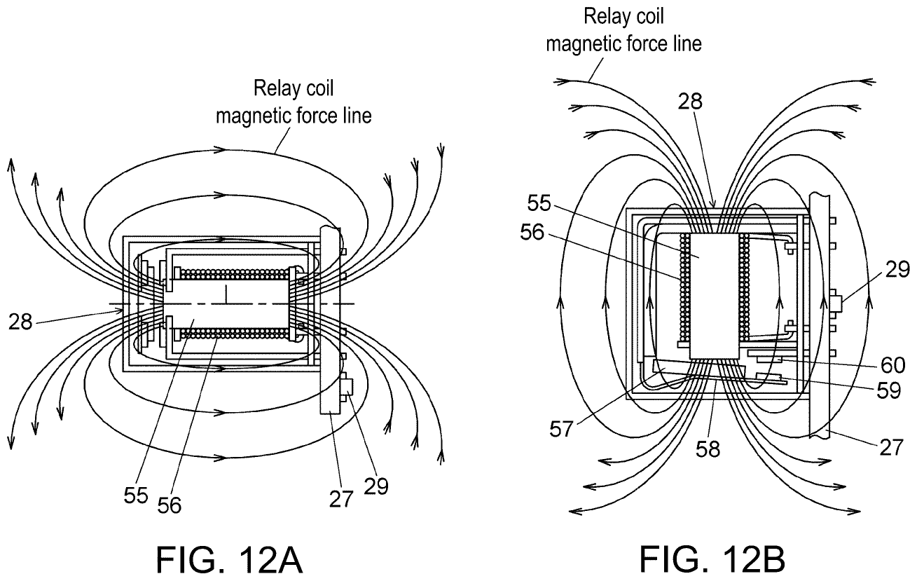

(A) of FIG. 12 is a diagram showing the magnetic force lines of the magnetic field (hereinafter referred to as “relay magnetic field”) generated by the relay coil 56 (the relay coil of this embodiment) in which the extending direction of the iron core 55 of the relay 28 is vertical to the surface of the stator substrate 27, and the relative arrangement of the relay 28 and the hall IC 29 for rotation detection. The relative arrangement of the relay 28 and the hall IC 29 shown in (A) of FIG. 12 corresponds to the relative arrangement of the relay 28 and the hall IC 29 shown in FIG. 5.

The hall IC 29 detects the magnetic field in the direction vertical to the surface of the stator substrate 27 (hereinafter referred to as “vertical direction of the substrate”) and does not detect the magnetic field in the direction parallel to the surface of the stator substrate 27 (hereinafter referred to as “parallel direction of the substrate”). Specifically, the hall IC 29 is configured to output voltage in response to the magnetic field in the vertical direction of the substrate and does not output voltage for the magnetic field in the parallel direction of the substrate. Therefore, if the hall IC 29 is placed in a position where the vertical component of the substrate of the relay magnetic field is large, there is a concern that the output signal of the hall IC 29 may undergo unintended changes. In other words, the original hall IC 29 is intended to be configured such that the output signal (level) changes based only on the magnetic field of the sensor magnet 42, but the magnitude and direction of the magnetic field passing through the hall IC 29 may change due to the relay magnetic field emitted from the relay 28 located on the opposite side of the sensor magnet 42, and there is a risk that the correct output signal corresponding to the position of the sensor magnet 42 may not be emitted. In this case, there is a concern that malfunction may occur.

In the arrangement example of (A) of FIG. 12, the hall IC 29 is located outside the existence range of the iron core 55 in the axial view (left-right direction view) of the iron core 55. Additionally, the hall IC 29 is located outside the existence range of the relay 28 when viewed from the vertical direction of the substrate (in the left-right direction view). With such an arrangement, in the case where the iron core 55 is vertical to the surface of the stator substrate 27, the vertical component of the substrate of the relay magnetic field at the position of the hall IC 29 becomes small, suppressing unintended changes in the output signal of the hall IC 29 and reducing the risk of malfunction. The relative arrangement of the hall IC 29 and the relay 28 may be any relative arrangement as long as the influence of the relay magnetic field on the output signal of the hall IC 29 falls within a substantially negligible range. For example, the hall IC 29 may be located outside the existence range of the iron core 55 (or outside the existence range of the relay coil 56) in the axial view of the iron core 55 and within the existence range of the relay 28 when viewed from the vertical direction of the substrate. Moreover, the relay 28 in this embodiment is a through-hole mounting type, and the terminals of the relay 28 protrude on the right side (the side facing the motor 30) of the stator substrate 27, where soldering is performed, resulting in a soldering area on the rear side of the mounting surface of the relay 28. If the hall IC 29 is located in this area, there is a risk of problems occurring during the assembly process, and it may be necessary to fix the hall IC 29 to the stator substrate 27 before fixing the relay 28 to the stator substrate 27, which may lead to deterioration in assemblability. In this embodiment, since the hall IC is located outside the existence range of the relay 28 (in a non-overlapping position) when viewed from the vertical direction of the substrate, such problems can be suppressed.

(B) of FIG. 12 is a diagram showing the relative arrangement of the relay 28 and the hall IC 29, and the magnetic force lines of the relay magnetic field, in the case where a relay 28 with the iron core 55 parallel to the surface of the stator substrate 27 is used. In the arrangement example of (B) of FIG. 12, at least a part of the hall IC 29 is located within the existence range of the iron core 55 in the axial view of the iron core 55. The hall IC 29 is located within the existence range of the relay 28 (or within the existence range of the iron core 55 or the relay coil 56) when viewed from the vertical direction of the substrate. The hall IC 29 is mounted on the opposite side of the surface of the stator substrate 27 on which the relay 28 is mounted. With such an arrangement, in the case where the iron core 55 is parallel to the surface of the stator substrate 27, the vertical component of the substrate of the relay magnetic field at the position of the hall IC 29 becomes small, suppressing unintended changes in the output signal of the hall IC 29 and reducing the risk of malfunction. In other words, when the magnetic field detection direction is (approximately) parallel to the extending direction of the iron core 55, it is sufficient to arrange the relay 28 and the hall IC 29 so as not to overlap when viewed from the vertical direction of the substrate, and when the magnetic field detection direction is (approximately) perpendicular to the extending direction of the iron core 55, it is sufficient to arrange the relay 28 and the hall IC 29 so as to overlap when viewed from the vertical direction of the substrate. Moreover, even in the case of a hall IC that detects a magnetic field in a direction parallel to the surface of the stator substrate 27, the occurrence of problems can be suppressed by applying the above relationship. In the configurations of (A) and (B) of FIG. 12, the iron plate 57 is arranged sufficiently apart so as not to operate due to the magnetic force of the sensor magnet 42. In other words, the relay 28 (iron plate 57) is configured not to turn ON or OFF by magnetic field generating elements other than the relay coil 56 (sensor magnet 42), thereby suppressing malfunction. It is preferable that the iron plate 57 is positioned in an area opposite to the sensor magnet 42 (on the left side of the center) within the relay 28.

The embodiment provides the following effects.

(1) As shown in (B) of FIG. 8 and FIG. 9, the common wire-connection connecting part (crossover line 40 and connect plate 41), the first wire-connection connecting part (relay for delta wire-connection), and the second wire-connection connecting part (relay for star wire-connection) are not all provided at the same location. Specifically, the common wire-connection connecting part is provided on the motor 30 (insulator 35), while the first wire-connection connecting part and the second wire-connection connecting part are provided on the stator substrate 27. In this embodiment, the coils of the same phase are configured to be connected in parallel in the delta wire-connection and in the star wire-connection. This parallel connection is made by the crossover line 40 supported by the insulator 35. Therefore, the parallel connection of U-phase stator coils U1 and U2 (hereinafter referred to as “U-phase parallel connection”), the parallel connection of V-phase stator coils V1 and V2 (hereinafter referred to as “V-phase parallel connection”), and the parallel connection of W-phase stator coils W1 and W2 (hereinafter referred to as “W-phase parallel connection”) are each completed on the stator 45 side without depending on the conductive pattern of the stator substrate 27. In other words, the coils of the same phase are connected in parallel at the stage before the stator substrate 27 is attached to the insulator 35. For this reason, compared to the case where the connection between stator coils in each parallel connection is configured by the conductive pattern of the stator substrate 27, the number of connect plates 41 (the number of locations of electrical connecting parts on the stator substrate 27) is reduced, and the complication of the conductive pattern of the stator substrate 27 or the increase in conductive patterns carrying large currents is suppressed. This allows the stator substrate 27 to be smaller, suppressing cost increases and size increase of product. On the other hand, the form of interconnection between the U-phase parallel connection, V-phase parallel connection, and W-phase parallel connection, that is, the stator coil wire-connection, is not fixed on the stator 45 side. Therefore, the stator coil wire-connection may be dynamically switched by the relays RY1 to RY5 provided on the stator substrate 27.

(2) As shown in FIG. 9, the winding step of the stator involves winding all slots at once and then cutting off unnecessary parts, which is efficient. Additionally, the connect plate 41 allows for both the connection of stator coils of the same phase and electrical connection with the stator substrate 27, thereby suppressing an increase in the number of parts and simplifying the structure.

(3) As shown in (A) of FIG. 2, the switching element 49 is arranged on the windward side of the cooling air flow compared to the relays 28. Therefore, the switching element 49, which generates more heat, may be cooled by the cooling air before it increases in temperature after cooling the relays 28, effectively suppressing the rise in FET temperature.

(4) The motor housing 21 that retains the stator core 34 is a single (non-divided) member. Therefore, in comparison to a case where the motor housing 21 has, for example, a two-part structure, the coaxial accuracy between the bearing retainer part 25 of the motor housing 21 and the stator core 34 is improved, and the coaxial accuracy between the motor shaft 31 and the stator core 34 is enhanced. Additionally, by making the stator substrate 27 compact, it becomes easier to insert the stator 45, which is unitized with the stator substrate 27, into the cylindrical motor housing 21 that is a single member. In the case of an insertion configuration, it is necessary to secure space for insertion inside the motor housing 21, but by making the stator substrate 27 compact, this space becomes smaller, allowing the motor housing 21 to be made smaller as well.

(5) The work machine 1 is configured such that when the FET temperature exceeds a predetermined temperature (high temperature protection threshold), the relay temperature becomes lower than the relay heat resistance temperature. Under this configuration, the work machine 1 does not have a dedicated thermistor for monitoring the relay temperature, and the calculation part 80 is configured to indirectly control the relay temperature not to exceed the relay heat resistance temperature by controlling the FET temperature not to exceed the FET heat resistance temperature. Therefore, it is possible to suppress cost increase due to providing a dedicated thermistor for monitoring the relay temperature, increase in the size of the stator substrate 27 for implementing such a thermistor, and consequently, increase in the size of the work machine 1.

(6) As shown in (A) of FIG. 12, in the case where the iron core 55 is perpendicular to the surface of the stator substrate 27, the hall IC 29 is positioned outside the existence range of the iron core 55 in an axial view of the iron core 55, and is also positioned outside the existence range of the relay 28 when viewed from the vertical direction of the substrate. As a result, the vertical component of the substrate of the relay magnetic field at the position of the hall IC 29 becomes small, suppressing unintended changes in the output signal of the hall IC 29 and reducing the risk of malfunction. Moreover, even in the case where the hall IC 29 is positioned outside the existence range of the iron core 55 (or outside the existence range of the relay coil 56) in an axial view of the iron core 55 and within the existence range of the relay 28 when viewed from the vertical direction of the substrate, it is possible to achieve a relative arrangement where the influence of the relay magnetic field on the output signal of the hall IC 29 falls within a substantially negligible range.

(7) As shown in (B) of FIG. 12, in the case where the iron core 55 is parallel to the surface of the stator substrate 27, the hall IC 29 is positioned outside the existence range of the iron core 55 in an axial view of the iron core 55, and is positioned within the existence range of the relay 28 (or within the existence range of the iron core 55 or the relay coil 56) when viewed from the vertical direction of the substrate. As a result, the vertical component of the substrate of the relay magnetic field at the position of the hall IC 29 becomes small, suppressing unintended changes in the output signal of the hall IC 29 and reducing the risk of malfunction.

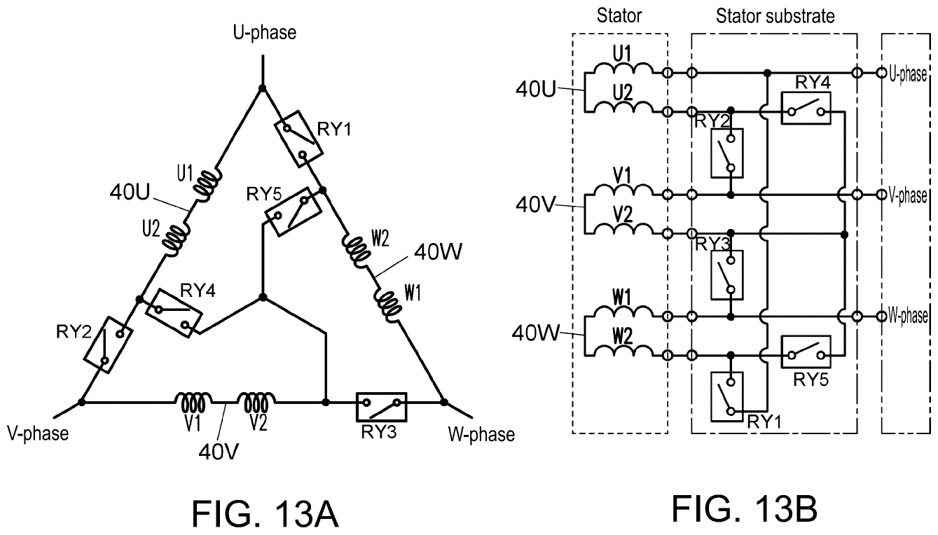

(Embodiment 2) (A) of FIG. 13 is a circuit diagram of a motor wire-connection circuit in a work machine according to Embodiment 2 of the disclosure. (B) of FIG. 13 is a circuit diagram showing the motor wire-connection circuit of (A) of FIG. 13 divided into the stator side and the stator substrate side. The following description will focus on the differences from Embodiment 1. The U-phase stator coils U1 and U2 are connected in series with each other, the V-phase stator coils V1 and V2 are connected in series with each other, and the W-phase stator coils W1 and W2 are connected in series with each other. In this embodiment, the common wire-connection connecting part includes crossover lines 40U, 40V, and 40W for connecting same-phase coils in series (for series connection), as shown in (B) of FIG. 13. Therefore, the common wire-connection connecting part (crossover line 40) and the first wire-connection connecting part (delta wire-connection relay) and the second wire-connection connecting part (star wire-connection relay) are not provided at the same location, that is, they are arranged in a distributed manner. This embodiment also provides the same effects as Embodiment 1.

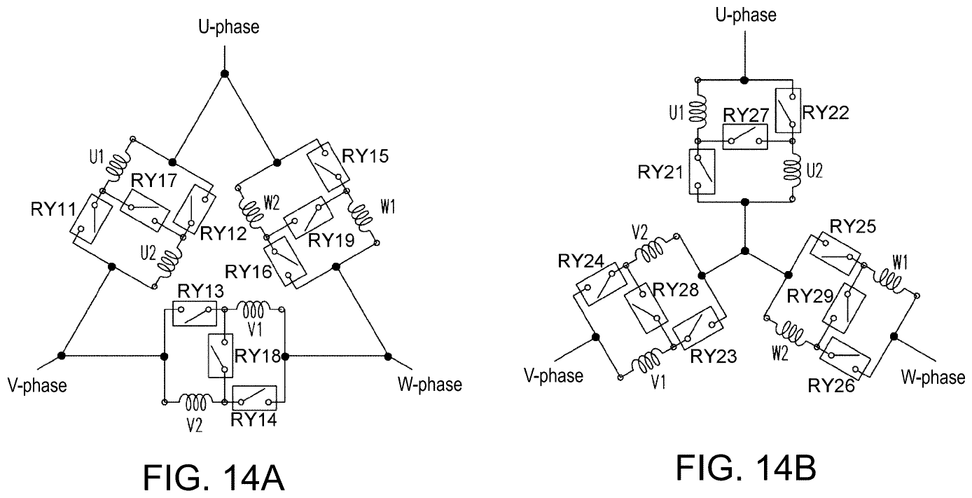

(Embodiment 3) (A) of FIG. 14 is a circuit diagram of a motor wire-connection circuit in a work machine according to Embodiment 3 of the disclosure. The following description will focus on the differences from Embodiment 1. In this embodiment, the connection form between different phases is the delta wire-connection, and relays RY11 to RY19 switch the connection form of a plurality of stator coils of each phase between series connection and parallel connection. By turning on the relays RY11 to RY16 and turning off relays RY17 to RY19, the U-phase stator coils U1 and U2 are connected in parallel with each other, the V-phase stator coils V1 and V2 are connected in parallel with each other, and the W-phase stator coils W1 and W2 are connected in parallel with each other. The relays RY11 to RY16 are examples of the first wire-connection connecting part (series connecting part). By turning off the relays RY11 to RY16 and turning on relays RY17 to RY19, the U-phase stator coils U1 and U2 are connected in series with each other, the V-phase stator coils V1 and V2 are connected in series with each other, and the W-phase stator coils W1 and W2 are connected in series with each other. Relays RY17 to RY19 are examples of the second wire-connection connecting part. In other words, the relays in this embodiment become a wire-connection connecting part (series-parallel switching connecting part) that switches between series and parallel connections. In this embodiment, the crossover lines and connect plates connecting stator coils of different phases, namely U-phase stator coil U1 and W-phase stator coil W2, U-phase stator coil U2 and V-phase stator coil V2, V-phase stator coil VI and W-phase stator coil W1, constitute the common wire-connection connecting part, and they are retained by the insulator 35, while each relay is retained by the stator substrate 27 or the inverter substrate 23. This embodiment also provides the same effects as Embodiment 1.

(Embodiment 4) (B) of FIG. 14 is a circuit diagram of a motor wire-connection circuit in a work machine according to Embodiment 4 of the disclosure. The following description will focus on the differences from Embodiment 1. In this embodiment, the connection form between different phases is star wire-connection, and relays RY21 to RY29 switch the connection form of a plurality of stator coils of each phase between series connection (first wire-connection) and parallel connection (second wire-connection). By turning on the relays RY21 to RY26 and turning off the relays RY27 to RY29, the U-phase stator coils U1 and U2 are connected in parallel with each other, the V-phase stator coils V1 and V2 are connected in parallel with each other, and the W-phase stator coils W1 and W2 are connected in parallel with each other. By turning off the relays RY21 to RY26 and turning on relays the RY27 to RY29, the U-phase stator coils U1 and U2 are connected in series with each other, the V-phase stator coils V1 and V2 are connected in series with each other, and the W-phase stator coils W1 and W2 are connected in series with each other. In this embodiment, the crossover lines and connect plates connecting stator coils of different phases, namely U-phase stator coil U2, V-phase stator coil V2, and W-phase stator coil W2, constitute the common wire-connection connecting part, and they are retained by the insulator, while each relay is retained by the stator substrate or the inverter substrate 23. This embodiment also provides the same effects as Embodiment 1.

Moreover, in the above-described embodiments, a distributed arrangement is described in which the common wire-connection connecting part is arranged on the motor 30 side, while the first wire-connection connecting part (relay for delta wire-connection) and the second wire-connection connecting part (relay for star wire-connection) are arranged on the stator substrate 27, but the disclosure is not limited to such arrangement.

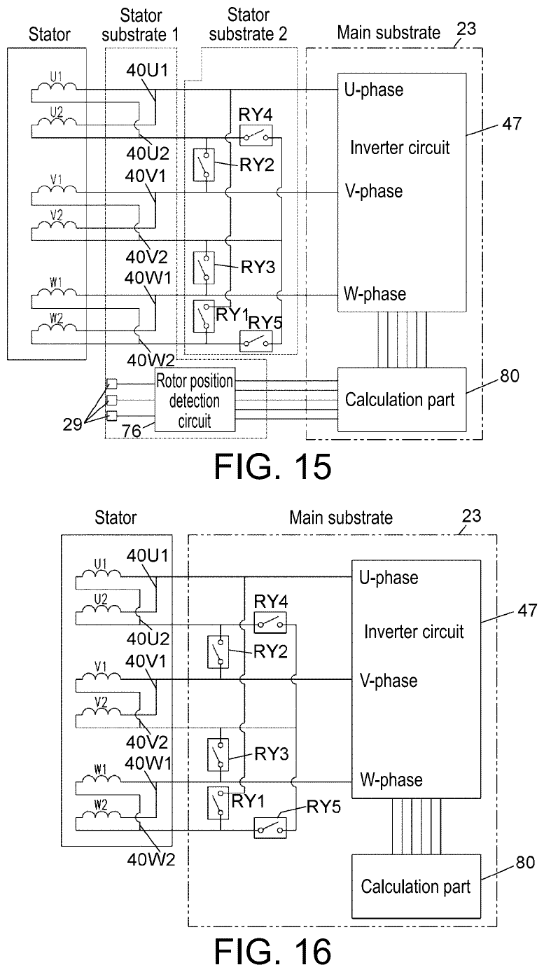

FIG. 15 is an example where the number of stator substrates is increased to two, with the common wire-connection connecting part arranged on one and the first and second wire-connection connecting parts arranged on the other. Although this results in an increased number of wirings to the insulator 35, totaling six, in this case, the part of the insulator that retains the crossover lines becomes unnecessary, thereby enabling the downsizing of the motor 30.

FIG. 16 shows a configuration where the common wire-connection connecting part is provided on the insulator 35, while the first and second wire-connection connecting parts are arranged on the inverter substrate 23 (main substrate). Moreover, in this embodiment, by controlling the motor 30 through vector control, the configuration eliminates the need for Hall ICs. Consequently, the stator substrate becomes unnecessary, enabling a reduction in the number of components.

The disclosure has been described using embodiments as examples, but the disclosure is not limited to these embodiments. Various modifications are possible within the scope described in the claims for each matter specifically explained in the embodiments.

The specific numerical values exemplified in the embodiments, such as the number of poles of the rotor and the number of slots of the stator, do not limit the scope of the disclosure in any way and may be arbitrarily changed according to the required specifications. At least a part of the relay 28 for wire-connection switching may be provided on the inverter substrate 23. The motor 30 may be sensorless driven. In other words, the Hall IC 29 may be omitted. In this case, although there is no problem that the output signal of Hall IC 29 is affected by the magnetism generated by relay 28, it is preferable that the relay 28 be configured such that it is not switched ON and OFF by the magnetism emitted from a magnetic source external to relay 28, such as rotor magnet 33. The work machine of the disclosure is not limited to a table-top cutting machine, but may be other types of cutting machines such as portable circular saws, or other types of work machines such as grinders.

### REFERENCE SIGNS LIST

1 . . . work machine, 2 . . . base, 3 . . . turntable, 4 . . . fence, 5 . . . holder, 6 . . . tilting shaft, 9 . . . oscillating shaft (shaft), 10 . . . cutting part (head part), 11 . . . gear case (saw cover), 12 . . . housing, 13 . . . handle housing, 14 . . . trigger switch (drive operation part), 15 . . . battery pack, 16 . . . battery pack mounting part, 17 . . . motor accommodating part, 18 . . . air inlet, 20 . . . cutting blade (saw blade), 21 . . . motor housing, 22 . . . cover, 23 . . . inverter substrate (first substrate), 24 . . . substrate case, 25 . . . bearing retainer part, 26 . . . left bearing, 27 . . . stator substrate (second substrate), 28 . . . relay, 29 . . . Hall IC (magnetic sensor), 30 . . . motor, 31 . . . motor shaft, 32 . . . rotor core, 33 . . . rotor magnet, 34 . . . stator core, 35 . . . left insulator, 36 . . . right insulator, 37 . . . stator coil, 38 . . . screw, 39 . . . notch, 40 . . . crossover line, 41,41U1,41U2,41V1,41V2,41W1,41W2 . . . connect plate, 42 . . . sensor magnet, 43U,43V,43W . . . power line, 44 . . . via hole, 45 . . . stator, 46 . . . motor wire-connection circuit, 47 . . . inverter circuit, 48 . . . resistor, 49 . . . switching element, 50 . . . fan, 51 . . . right bearing, 52 . . . winding transmission mechanism, 53 . . . deceleration mechanism, 55 . . . iron core (magnetic core), 56 . . . relay coil, 58 . . . leaf spring, 59 . . . movable contact, 60 . . . fixed contact, 62 . . . yoke part, 63 . . . teeth part, 71 . . . current detection circuit, 72 . . . voltage detection circuit, 73 . . . operation amount detection circuit, 74 . . . temperature detection circuit, 75 . . . thermistor (temperature detection element), 76 . . . rotor position detection circuit, 77 . . . rotation speed detection circuit, 78 . . . relay drive circuit, 79 . . . control signal output circuit, 80 . . . calculation part (control part), RY1-RY5,RY11-RY19,RY21-RY29 . . . relay, U1,U2 . . . U-phase stator coil, V1, V2 . . . V-phase stator coil, W1,W2 . . . W-phase stator coil.

1. A work machine, comprising:
a brushless motor having a plurality of coils, and having a stator and a rotor;
substrate connected to the brushless motor;
an inverter circuit configured to supply current to the plurality of coils; and
a wire-connection circuit connected to the inverter circuit and configured to wire-connect the plurality of coils,
wherein the wire-connection circuit is configured to have a plurality of switching elements and enable wire-connection of the plurality of coils to be a delta wire-connection or a star wire-connection by the plurality of switching elements,
at least one of the plurality of switching elements is provided on the substrate,
the plurality of switching elements include a first switching element that becomes conductive only in a case of the wire-connection of the plurality of coils being the delta wire-connection, and a second switching element that becomes conductive only in a case of the wire-connection of the plurality of coils being the star wire-connection;
the wire-connection circuit includes a common wire-connection connecting part that connects the plurality of coils in parallel at a location different from the substrate and becomes conductive in both the delta wire-connection and the star wire-connection,
the plurality of coils include a first coil and a second coil constituting a first phase,
the substrate is provided with a first connecting part and a second connecting part for supplying current to the plurality of coils,
wherein the common wire-connection connecting part comprises:
a first connection receiving part electrically connected to one end of the first coil and one end of the second coil and electrically connected to the first connecting part; and
a second connection receiving part electrically connected to the other end of the first coil and the other end of the second coil and electrically connected to the second connecting part,
wherein in either case where the wire-connection of the plurality of coils is the delta wire-connection or the star wire-connection, current is supplied to the first coil and the second coil via the first connection receiving part and the second connection receiving part.

2. A work machine, comprising:
a motor having a plurality of coils;
an insulator provided on the motor;
a circuit board fixed to the insulator;
an inverter circuit configured to supply current to the plurality of coils; and
a wire-connection circuit connected to the inverter circuit and configured to wire-connect the plurality of coils,
wherein the wire-connection circuit is configured to enable wire-connection of the plurality of coils to be a delta wire-connection or a star wire-connection, and comprises:
a first switching element that becomes conductive only in the case where the wire-connection of the plurality of coils is a delta wire-connection;
a second switching element that becomes conductive only in the case where the wire-connection of the plurality of coils is a star wire-connection; and
a common wire-connection connecting part configured to connect between the plurality of coils and becomes conductive in both the delta wire-connection and the star wire-connection,
wherein the first switching element and the second switching element are provided on the circuit board, and
the common wire-connection connecting part comprises a crossover line, which is configured to connect two different coils among the plurality of coils and is supported by the insulator.

3. A work machine, comprising:
a motor having a plurality of coils and comprising a stator, and a rotor;
a substrate fixed to the stator;
an inverter circuit configured to supply current to the plurality of coils; and
a wire-connection circuit connected to the inverter circuit and configured to wire-connect the plurality of coils,
wherein the wire-connection circuit comprises:
a first switching element that becomes conductive only in the case where a wire-connection of the plurality of coils is a first wire-connection;
a second switching element that becomes conductive only in the case where the wire-connection of the plurality of coils is a second wire-connection; and
a common wire-connection connecting part configured to connect between the plurality of coils and becomes conductive in both the first wire-connection and the second wire-connection,
wherein among the common wire-connection connecting part, the first switching element, and the second switching element, one is provided on the substrate, and at least one of the other two is provided separately from the substrate.

4. The work machine according to claim 2, wherein the common wire-connection connecting part connects coils of same phase among the plurality of coils.

5. The work machine according to claim 4, wherein the common wire-connection connecting part connects the coils of same phase in parallel.

6. The work machine according to claim 3, wherein the first wire-connection is a delta wire-connection, and the second wire-connection is a star wire-connection.

7. The work machine according to claim 1, wherein the substrate is arranged at one end of the stator in an axial direction of the motor.

8. The work machine according to claim 3, wherein the first switching element is provided on the substrate.

9. The work machine according to claim 8, wherein the second switching element is provided on the substrate.

10. The work machine according to claim 1, wherein the first switching element and the second switching element are through-hole mounted type relays.

11. (canceled)

12. The work machine according to claim 1, wherein the common wire-connection connecting part comprises a crossover line supported by the motor, the crossover line being used for parallel connection of the first coil and the second coil.

13. The work machine according to claim 12, wherein an insulator is provided on the stator, the crossover line is retained by the insulator, and at least one of the first switching element and the second switching element is provided on the substrate.

14. The work machine according to claim 3, wherein the common wire-connection connecting part is provided on the motor, and the inverter circuit, the first switching element, and the second switching element are provided on the substrate.

15. The work machine according to claim 3, wherein at least one of the inverter circuit, the first switching element, and the second switching element is provided on a second substrate other than the substrate, and the common wire-connection connecting part is provided on the substrate.

16. The work machine according to claim 1,
wherein the brushless motor is a 3-phase 6-slot motor,
the plurality of coils comprise a third coil and a fourth coil constituting a second phase, and a fifth coil and a sixth coil constituting a third phase, and
the substrate is provided with a third connecting part, a fourth connecting part, a fifth connecting part, and a sixth connecting part,
wherein the common wire-connection connecting part comprises:
a third connection receiving part that electrically connects one end of the third coil and one end of the fourth coil and is electrically connected to the third connecting part;
a fourth connection receiving part that electrically connects the other end of the third coil and the other end of the fourth coil and is electrically connected to the fourth connecting part;
a fifth connection receiving part that electrically connects one end of the fifth coil and one end of the sixth coil and is electrically connected to the fifth connecting part; and
a sixth connection receiving part that electrically connects the other end of the fifth coil and the other end of the sixth coil and is electrically connected to the sixth connecting part,
wherein in either case where the wire-connection of the plurality of coils is the delta wire-connection or the star wire-connection, current is supplied to the plurality of coils via the first connection receiving part, the second connection receiving part, the third connecting part, the fourth connecting part, the fifth connecting part, and the sixth connecting part.

17. The work machine according to claim 3, wherein the common wire-connection connecting part connects coils of same phase among the plurality of coils.

18. The work machine according to claim 3, wherein the substrate is arranged at one end of the stator in an axial direction of the motor.

19. The work machine according to claim 2, wherein the first switching element and the second switching element are through-hole mounted type relays.

20. The work machine according to claim 3, wherein the first switching element and the second switching element are through-hole mounted type relays.

21. The work machine according to claim 3, wherein the common wire-connection connecting part comprises a crossover line supported by the motor, the crossover line being used for parallel connection of the first coil and the second coil.
